(19) United States
(12) Patent Application Publication
(10) Pub. No.: US 2004/0259602 A1
(43) Pub. Date: Dec. 23, 2004

(54) Apparatus and method for reducing sound in surrounding area resulting from speaking into communication device

(76) Inventor: Naomi Zack, Eugene, OR (US)

Correspondence Address: BIRCH STEWART KOLASCH & BIRCH, PO BOX 747, FALLS CHURCH, VA, 22040-0747, US

(21) Appl. No.: 10/796,547

(22) Filed: Mar. 9, 2004

Related U.S. Application Data
(60) Provisional application No. 60/479,798, filed on Jun. 18, 2003.

(51) Int. Cl. H04B 1/38; H04M 1/00

(52) U.S. Cl. 455/570; 455/575.1; 455/575.3

(57) ABSTRACT

Apparatus and method for reducing the sound in surrounding areas when a user is speaking into a communication device such as wireless cell phone. A communication device may be provided with a sound-absorbing body and attachment means may be provided for positioning the body in an operable position adjacent to or in proximity to the receiver or input area of the phone without substantially blocking passage of the speech from the user into the input area. The body may be in the form of a talk screen, which is selectively positionable between an operable position described above, and a non-operable position. Desirably, when in the non-operative position, the apparatus is more compact and does not occupy additional space or as much space as when in the operative position, and is more convenient to transport and store. The illustrated structures show various forms or shapes of screens, some of which are generally flat, while others are arcuate or curved to better provide the desired containment and absorbing.

### FIELD OF INVENTION

Communication Devices

### BACKGROUND

The present invention relates to the interaction between telephone users, particularly those who talk on wireless cell phones, and their environment. In recent decades, telephone technology has focused on matters within telephone instruments without due regard to the effects of their use on other people present during conversations. People who use wireless phones often annoy others with their sides of conversations, are disturbed by their own lack of privacy when others cannot help but overhear their sides of conversations, and have difficulty transmitting their voices clearly when there is background noise while they are talking. People who use attached land phones or mobile land phones often have the same problems of annoying others present, insufficient privacy for themselves and interference by background noise of a clear transmission of what they are saying into the phone.

### SUMMARY OF DISCLOSURE

A body of sound-absorbing material such as a phone talk screen can be attached to the speaking end of any telephone, particularly wireless phones, and it will muffle, block and reduce the volume of what people speaking into telephones say, so that others present during phone conversations are less disturbed by the volume of what they overhear. A phone talk screen will also increase phone users' sense of privacy, and minimize background noise interference with the sounds that are transmitted to the person on the other end of the phone. The phone talk screen may consist of sound-absorbing material mounted into a stable frame that attaches to the mouth end of phones, either as an accessory that is sold after the phone is manufactured, or as a permanent part of the housing of telephone or cell phone handsets, which becomes a component of the housing of the handset when it is first manufactured. The phone talk screen is absorbent toward that part of the sound of the voice of a person talking on the phone, which is not being directed into the phone for transmission.

The illustrated phone talk screen affects the process of using wired and attached land phones, and wireless or cell phones, by improving the auditory environment of others present during phone conversations. It also improves the psychological and audible quality of phone conversations for the benefit of both parties to a phone conversation. This has the overall effect of allowing phone users, particularly wireless or cell phone users, to speak in lower and more modulated voices, which further benefits those inadvertent listeners in the vicinity of their sides of phone conversations.

### IN THE DRAWINGS

FIG. 1 schematically illustrates a presently preferred embodiment of apparatus which includes a phone talk screen attached to a wireless phone, the screen being shown in an operative position.

FIG. 2 schematically illustrates the apparatus of FIG. 1 with the screen shown repositioned to an inoperative position.

FIG. 3 schematically illustrates another presently preferred embodiment of apparatus which includes a talk screen shown pivotally mounted to the lower end of a cell phone, the screen being opened to an operative position.

FIG. 4 schematically illustrates the apparatus of FIG. 3, the screen shown closed to an inoperative position.

FIG. 4A schematically illustrates a variation of the screen of FIGS. 3-4.

FIG. 4B schematically illustrates another variation of the screen of FIGS. 3-4.

FIG. 5 schematically illustrates another presently preferred embodiment of apparatus in the form of an arcuate-shaped phone talk screen attached to a wired land phone handset.

FIG. 6 schematically illustrates another presently preferred embodiment of apparatus which includes an enlarged, arcuate-shaped phone talk screen attached to a mobile land phone.

FIG. 7 schematically illustrates another presently preferred embodiment of apparatus which includes a large generally circular phone talk screen that is attached to a microphone for a hands-free attachment to a phone.

FIG. 8 schematically illustrates another presently preferred embodiment of apparatus which includes a generally conically-shaped phone talk screen attached to a microphone connected to a device such as a sound recorder.

### DETAILED DESCRIPTION OF THE DRAWINGS

In general, a sound-absorbing body may take the form of a phone talk screen that is mounted on a cell phone or other communication device and faces forward toward the user. The illustrated screen comprises a layer of sound-absorbing material that is mounted, framed or glued onto a rigid or semi-rigid backing or frame. The talk screen may be generally flat or concave so as to generally intercept some of the peripheral or outwardly emanating sounds issuing from the user speaking into the phone, without significantly blocking the sound that goes directly into the input or receiving area of the phone intending to receive the sounds. The sound absorbing material may consist of, but not be limited to one or a combination of: cork, foam, rubber, natural or artificial compounds of inert material, and material containing electronic devices that will interfere with and absorb sound. The same or a different kind of sound-absorbing material that absorbs the sound of the speaker's voice may also be mounted onto the back of the phone talk screen in order to directly absorb sounds from the background.

Phone talk screens may be attached to the handsets of wired and mobile land phones and wireless cell phones, as a permanent part of their manufacture, or removably attached to them as accessories with snaps, tension frames, hinges, slides, Velcro closures or the like.

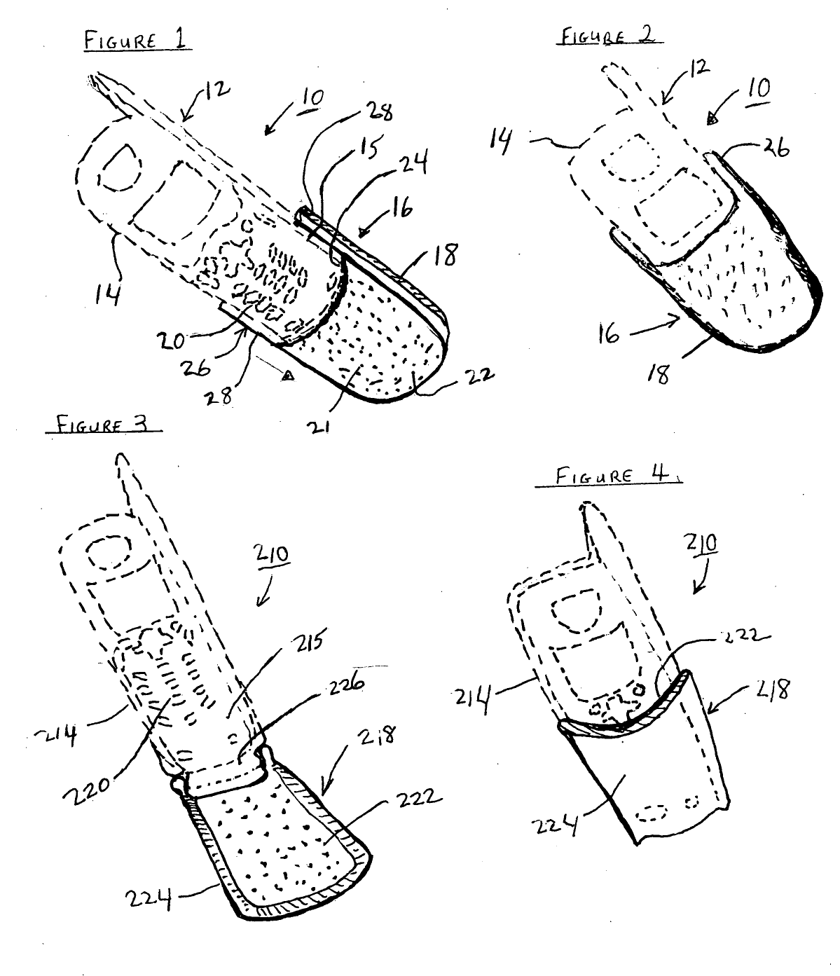

FIGS. 1 and 2 illustrate a presently preferred embodiment of apparatus 10 that includes a communication device 12 in the form of a wireless cell phone 14 and a sound-absorbing body 16 in the form of a generally envelope-shaped phone talk screen 18. The screen 18 is mounted on the phone 14 for movement between operative and inoperative positions.

FIG. 2 illustrates the screen 18 telescoped over the lower end 15 of the phone 14 in a non-operative position when the phone is not in use so as not to occupy additional space.

When the user desires to use the phone 14, the screen 18 may be slid downwardly to the operative position as shown in FIG. 1 where the receiver or input area 20 of the phone 14 is exposed so that the user may speak directly into that receiver. The front portion 21 of the envelope-shaped screen 18 has a layer 22 of sound absorbent material, which is thus positioned in proximity or adjacent to the receive or input area 20 of the phone when the screen is in the operative position. The screen thus absorbs a quantity of the sound from the voice of the user speaking into the phone and reduces the amount of that sound which travels to the surrounding or ambient areas. The illustrated screen 18 has a rigid or semi-rigid base or backing 24 made of plastic, metal or other suitable material that supports the layer 22 of sound-absorbing material. The illustrated screen 18 is generally envelope shaped as noted above, open at its upper end, and shaped and proportioned to telescope over the lower end 15 of the phone. Suitable attachment means 26 may be provided to maintain the screen 18 in the inoperative position shown in FIG. 2, and to allow its movement to the operative position as shown in FIG. 1. Such attachment means 26 may take various forms such as a tongue-in-groove arrangement 28 between the screen 18 and the phone 14 at either side. The screen may be constructed so as to optionally detach from the phone when it is so desired by the user.

The screen may take alternate configurations. For example, FIG. 2-A illustrates another presently preferred embodiment of apparatus 110 which includes cell phone 114 and an envelope-shaped screen 118. Screen 118 has an added upper portion 130 and added side portions 132 which combine with lower position 121 to define an opening 133. That screen 118 may be moved to the operative position shown in FIG. 2-A where the opening 133 is positioned over the receiver or input area 120 of the phone, while sound-absorbing portions 130, 132, 121 generally surrounding that area. This provides added sound absorbing capability for the screen 118. When the phone 114 is not in use, the envelope-shaped screen 118 may slide upwardly to reduce the overall size of the apparatus 110.

A variety of other shapes and configurations for the sound absorbing material may be provided, some of which are specifically illustrated in further embodiments of the device.

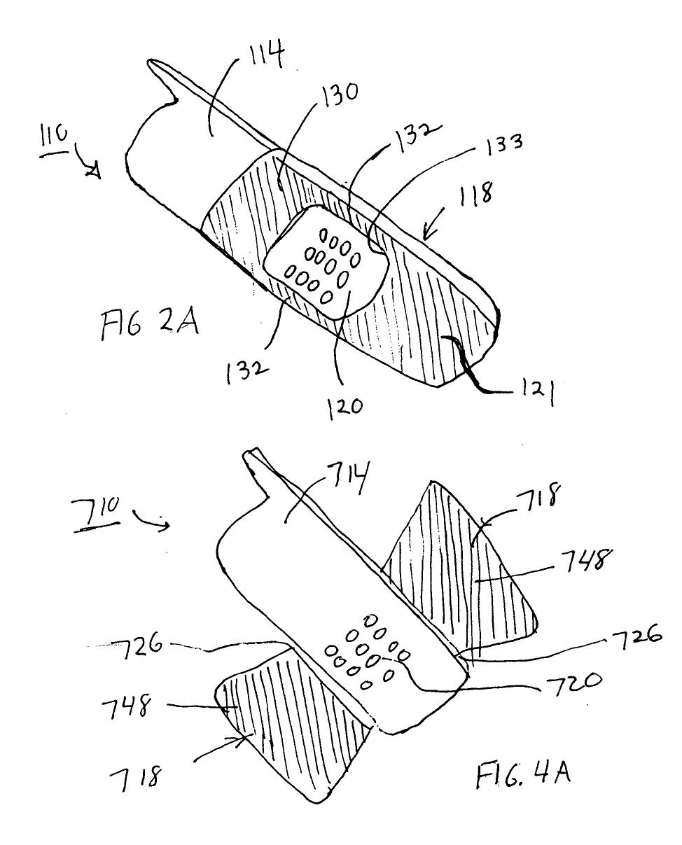

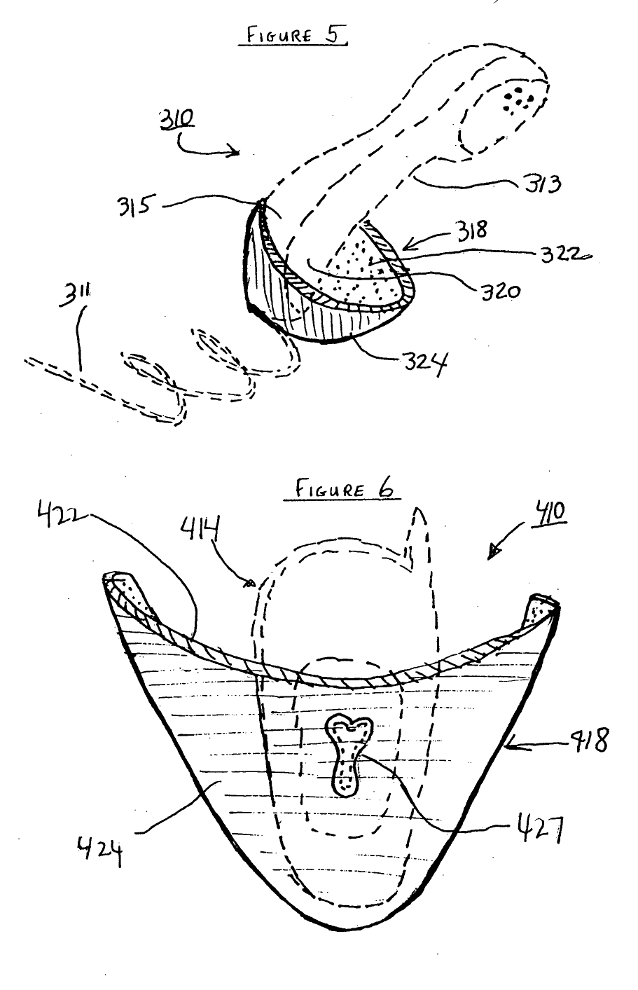

FIGS. 3 and 4 illustrate another presently preferred embodiment of apparatus 210 that includes a generally flat phone talk screen 218 that is pivotally hinged by suitable attachment means 226 to the lower end 215 of a wireless cell phone 214. The screen 218 includes a rigid or semi-rigid backing 224 having a layer 222 of sound-absorbing material secured to its forward surface (when opened to the operative position shown in FIG. 3).

FIG. 4 illustrates the talk screen 218 in an inoperative position, folded up against the lower front of the cell phone 214. In this condition the screen 218 is compact and out of the way when the phone is not in use. When the user wishes to utilize the phone, the screen may be pivoted to an operative position as shown in FIG. 3 where it is adjacent to but spaced away from the receiver or input area 220. Some speech from the user will go directly to the receiver or input area 220, while other or peripheral portions of that speech will impact and be muffled or absorbed by the sound-absorbent material 222 of the screen 218.

FIG. 4-A illustrates another presently preferred embodiment of apparatus 710 which includes a cell phone 714 and a sound-absorbing body 716 in the form of a pair of side screens 718. Each of the side screens 718 is pivotally mounted by suitable attachment means or hinges 726 along one side of the phone 714 adjacent the input area 720. When in outwardly extending operative positions as shown in FIG. 4-A, the screens 718 extend outwardly to either side of the phone. The layer of sound-absorbing material 722 of the screens 718 faces forwardly toward the user. When the phone 714 is not in use, the screens 718 may be pivoted inwardly so as to generally overly the input area 720 (with one screen overlying the other). The screens 718 may have a suitable shape or curvature so as to generally conform to one another and the front face of the phone which they overly.

FIG. 5 illustrates another presently preferred embodiment of apparatus 310 that includes a generally hemispherically-shaped phone talk screen 318 for use with a handset 313 connected through a suitable wire 311 to a communication device (not shown). As shown in that drawing, the screen 318 is attached so as to generally surround the receiver or input area 320 at the lower end 315 of the handset 313. The screen 318 may include an outer rigid or semi-rigid base 324 supporting or frame with an interior layer 322 of sound-absorbing material. The sound-absorbing material 322 is thus adjacent or in proximity to the speech receiving input area 320 of the handset 313 but is spaced therefrom to allow direct access of the speaker input into that receiver. Such a screen 318 may be permanently attached to the handset 313 or could be a split section (not shown) sufficiently flexible so it may be detachably positioned as shown in FIG. 5. Thus, a user might carry the screen 318 with them and attach it to a handset 313 which they are using in an airport or train station.

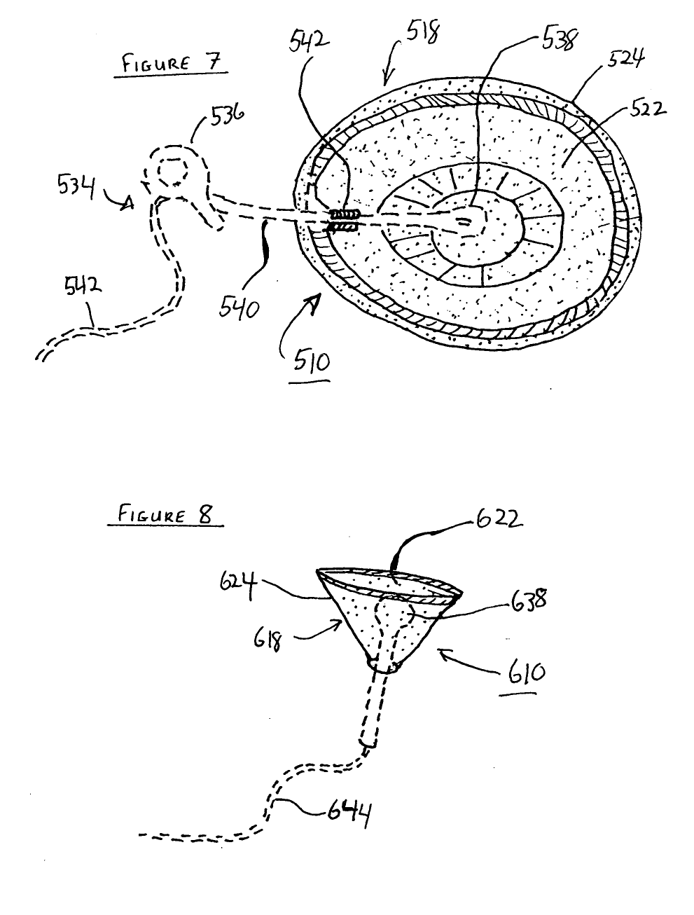

FIG. 6 is a rear view of still another presently preferred embodiment of apparatus 410 that includes a phone talk screen 418 removeably attached to the rear of a mobile land phone 414. This illustrated screen 418 is a generally arcuate-shape having a rigid or semi-rigid rear outer base or frame 424 which supports a layer 422 of forwardly facing sound-absorbing material. Suitable attachment means 426 may be provided such as a Velcro closure 427 for removably securing the screen 418 to the rear of the land phone 414. The screen 418 is proportioned to extent substantially outwardly to either side of the land phone 414 so that when the speaker speaks into the receiver or input area at the front of the land phone, a good deal of the peripheral or diverging sound from their speech will be absorbed by the sound-absorbing material of the screen. Thus, the screen 418 is adjacent to or in proximity to that receiver or input area 420, but does not block direct access of the speech to the input area. When not in use, the screen 418 may be detached and stored. Alternatively, such a screen might be permanently manufactured as part of a land phone, however this would generally tend to be less convenient because of the size and expanse of this particular screen.

FIG. 7 shows yet another presently preferred embodiment of apparatus 510 that includes a phone talk screen 518 which is particularly designed for use with a hands free attachment 534 for a mobile cell phone or other communication device (not shown). The illustrated attachment 534 includes an earpiece 536 connected by an elongated section 540 to a microphone 538 for the user to speak into. The earpiece 536 is connected by a cord 542 to the communication device. This illustrated talk-screen 518 may be generally circular cup-shaped and it may be mounted on the attachment 534 so that it is positioned rearwardly of the microphone 538 with the user speaking into the microphone from the front. The drawing illustrates suitable attachment means in the form of a clamp 542 for mounting the screen 518 on the elongated section 540 between the microphone 538 and the earpiece 536. The screen 518 may have a rigid or semi-rigid base or backing 524 supporting a layer of sound-absorbing material 522 on the side facing the user. Thus, the path to the microphone 538 is unobstructed, but the sound-absorbing material 522 of the screen 518 will absorb a good deal of the sound from the user's voice without allowing it to continue into the surrounding or ambient area. Such a screen 518 also tends to hide the lips of the user from observation, which is an added advantage for such a screen.

FIG. 8 illustrates another presently preferred embodiment of apparatus 610 which includes a conically-shaped phone talk screen 618 attached to and surrounding a sound recording microphone 638. The screen 618 may comprise an outer backing 624 and an inner sound-absorbing layer 622. The microphone 638 may be connected by a suitable cord 644 to a communication device such as a recorder (not shown).

Various other modifications and changes may be made in the illustrated structures without departing from the spirit and scope of the present invention as set forth in the following claims.

What is claimed:

1. Communication apparatus comprising, in combination:
a. a communication device having an external input area into which the user of the device speaks to communicate with the device,
b. a sound-absorbing body, and
c. attachment means for mounting said body on said communication device in an operative position in proximity to said input area but without blocking a substantial portion of said input area, said body generally facing the user speaking into the input area to thereby reduce sound emitted to the surrounding environment from such speaking.

2. The apparatus of claim 1 wherein said body is positionable both in an operable position and in a non-operable position.

3. The apparatus of claim 2 wherein said body is permanently connected to said communication device and is selectively movable by the user between an operable position and a non-operable position.

4. The apparatus of claim 2 wherein said body is removeably attachable to said communication device in an operative position, and is selectively removable by the user to a non-operative position.

5. The apparatus of claim 1 wherein said attachment means is a pivoted hinge, and said body is in the form of a generally flat screen movable between a non-operative position which reduces the space occupied by the apparatus and an operative position extending outwardly from said input area.

6. The apparatus of claim 5 further including a second screen, said screens movable to outwardly extending operative positions at either side of said input area

7. The apparatus of claim 2 wherein said body is in the form of a sleeve slidable between an non-operative generally telescoped over said communication device and an operative position adjacent to said input area.

8. The apparatus of claim 1 wherein said body extends substantially outwardly of said input area so as to block emanation of sound from the user speaking into said input area.

9. The apparatus of claim 1 wherein said body is in the form of an arcuate surface extending around but spaced from said input area.

10. The apparatus of claim 1 wherein said body substantially surrounds said input area.

11. The apparatus of claim 1 wherein said body comprises a rigid or semi-rigid backing that supports a layer of sound-absorbing material.

12. The apparatus of claim 1 wherein said body is comprised of one or more from the following group: cork, rubber, foam, natural or artificial compounds of inert material, and electronic devices that absorb sound.

13. A method of utilizing a communication device so as to reduce the ambient sound produced when the user speaks into the device, said communication device having an input area into which the user of the device speaks for communicating with the device, said method comprising the steps of:
a. providing a communication device having an external input area,
b. providing a sound-absorbing body,
c. positioning the body in an operative position which is generally facing the user speaking into the input area, is in proximity to the input area, but does not block a substantial portion of the input area, such positioning of the body being for the purpose of allowing speech from the user to freely and directly reach the input area while reducing the peripheral or emanating speech from that speaker reaching the surrounding environment.

14. The method of claim 13 comprising the additional step of selectively positioning the body in a non-operative position when the communication device is not in use to reduce the external envelope of the communication device.

15. The method of claim 14 wherein the selectively positioning step comprises removing the body from the communication device.

16. The method of claim 14 wherein the body is permanently attached to the communication device, and the selectively positioning step comprises moving the attached body.

17. For use with a communication device having an external input area into which the user of the device speaks to communicate with the device, sound-absorbing apparatus comprising:
a. sound-absorbing screen that includes a rigid or semi-rigid backing panel and a layer
a. sound-absorbing screen that includes a rigid or semi-rigid backing panel and a layer of sound-absorbing material mounted on the backing panel, and
b. attachment means for mounting said sound-absorbing screen on said communication device in an operative position in proximity to said input area but without blocking a substantial portion of said input area, said sound-absorbing material generally facing the user speaking into the input area to thereby reduce sound emitted to the surrounding environment from the such speaking.

18. The apparatus of claim 17 wherein said attachment means affords movement of said sound-absorbing screen between said operable position and a non-operable position which reduces the space occupied by the communication device and the sound-absorbing apparatus.

19. The apparatus of claim 17 wherein said screen extends substantially outwardly of said input area so as to block emanation of sound from the user speaking into said input area.

20. The apparatus of claim 17 wherein said sound-absorbing material comprises one or more from the following group: cork, rubber, foam, and natural or artificial compounds of inert material.
